(19) United States
(12) Patent Application Publication
(10) Pub. No.: US 2026/0225704 A1
(43) Pub. Date: Aug. 6, 2026

(54) DISTRIBUTED CONTROL SYSTEM ARCHITECTURE FOR AN ELECTRIC MARINE VESSEL

(71) Applicant: VISION MARINE TECHNOLOGIES, BOISBRIAND (CA)

(72) Inventor: XAVIER MONTAGNE, LAVAL (CA)

(21) Appl. No.: 19/046,708

(22) Filed: Feb. 6, 2025

(51) Int. Cl. B63H 23/24; B60L 50/60; B63H 21/17; H04L 12/40

(52) U.S. Cl. CPC B63H 23/24; B60L 50/60; B63H 21/17; H04L 12/40045; B60L 2200/32; B60L 2210/10; H04L 2012/40215; H04L 2012/40286

(57) ABSTRACT

Various embodiments relate to a distributed control system architecture for an electric marine vessel apparatus that includes a vessel control unit (VCU) and a plurality of powertrain components, including at least one high voltage (HV) battery, a power distribution unit (PDU) connected to the HV battery via first HV connections, and an electric outboard motor connected to the PDU via second HV connections. The PDU selectively couples the electric outboard motor to power supplied by the HV battery. A control area network (CAN) bus connects the VCU to the powertrain components, with each component having a respective controller configured to execute commands from the VCU over the CAN bus.

### FIELD OF THE TECHNOLOGY

The present disclosure relates to methods, apparatuses, and computer program products for a distributed control system architecture for an electric marine vessel.

### BACKGROUND

Traditional marine vessels have predominantly relied on internal combustion engines (ICE) for propulsion, which typically involve complex mechanical systems and fuel-based power sources. These systems often require extensive maintenance and are subject to environmental regulations due to emissions. In recent years, there has been a shift towards integrating electric propulsion systems in marine vessels, driven by the need for cleaner and more efficient alternatives. Early electric marine vessels often utilized low-voltage battery systems and direct current (DC) motors, which limited their power output and range, making them suitable primarily for small boats or short-distance travel.

As technology advanced, the introduction of high voltage (HV) battery systems allowed for greater power capacity and efficiency in electric marine vessels. These systems enabled the use of more powerful electric motors, which could support larger vessels and longer travel distances. However, integrating HV systems into marine vessels presented challenges, such as ensuring safe and efficient power distribution and managing the complex interactions between various powertrain components. Traditional approaches often involved custom wiring solutions and proprietary communication systems, which could complicate maintenance and scalability.

### SUMMARY

According to embodiments of the present disclosure, various methods, apparatuses, and computer program products for a distributed control system architecture for an electric marine vessel are described herein. In some aspects, an electric marine vessel apparatus includes a vessel control unit (VCU) and a plurality of powertrain components, including at least one high voltage (HV) battery, a power distribution unit (PDU) connected to the HV battery via first HV connections, and an electric outboard motor connected to the PDU via second HV connections. The PDU selectively couples the electric outboard motor to power supplied by the HV battery. A control area network (CAN) bus connects the VCU to the powertrain components, with each component having a respective controller configured to execute commands from the VCU received over the CAN bus. This configuration reduces complexity by utilizing a CAN bus for control, thus eliminating the need for traditional wiring, reducing system complexity and weight.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A sets forth a block diagram of an example electric marine vessel in accordance with at least one embodiment of the present disclosure.

FIG. 1B sets forth a block diagram of an example marine propulsion system of an electric marine vessel in accordance with at least one embodiment of the present disclosure.

FIG. 1C sets forth a block diagram of an example high voltage battery of an electric marine vessel in accordance with at least one embodiment of the present disclosure.

FIG. 1D sets forth a block diagram of an example power distribution unit in accordance with at least one embodiment of the present disclosure.

FIG. 1E sets forth a block diagram of an example vessel control unit of an electric marine vessel in accordance with at least one embodiment of the present disclosure.

FIG. 2A sets forth a block diagram of an example security management module for authenticating powertrain components of an electric marine vessel in accordance with at least one embodiment of the present disclosure.

FIG. 2B sets forth another example of the security management module of FIG. 2A.

FIG. 3 sets forth a block diagram of an example distributed control system architecture for an electric marine vessel in accordance with at least one embodiment of the present disclosure.

FIG. 4 sets forth a block diagram of an example powertrain component for a distributed control system architecture for an electric marine vessel in accordance with at least one embodiment of the present disclosure.

FIG. 5 sets forth a flow chart of an example method of operating a distributed control system architecture for an electric marine vessel in accordance with at least one embodiment of the present disclosure.

### DETAILED DESCRIPTION

Advances in battery technology have paved the way for full-electric vehicles. Building on those advances, technology to enable full-electric watercraft has been widely adopted. However, the challenges of designing electric vehicles are different from the challenges of designing electric boats. The transformation of existing watercraft platforms to a full-electric platform also poses a different set of challenges. A particular challenge faced by electric watercraft is the weight and complexity of wire harnesses used to connect various powertrain components, and the scalability of the powertrain system.

The present invention relates to a distributed control system architecture that provides local controllers in each powertrain component that independently manage the operation of the powertrain component. After using an ignition signal to wake up the controller, all control signaling is carried out by control commands that are transmitted over the CAN bus. Based on these commands, the local controller independently operates the powertrain component. This distributed control system architecture reduces complexity by utilizing a CAN bus for control, thus eliminating the need for traditional wiring. The distributed control system architecture in accordance with the present disclosure enhances reliability by ensuring that each component operates independently while being coordinated by the VCU. The distributed control system architecture in accordance with the present disclosure improves safety with HVIL connections that provide a robust safety mechanism, preventing accidental operation and ensuring proper system integration. The distributed control system architecture in accordance with the present disclosure improves scalability in that the modular design allows easy integration of additional components or functionalities without significant redesign.

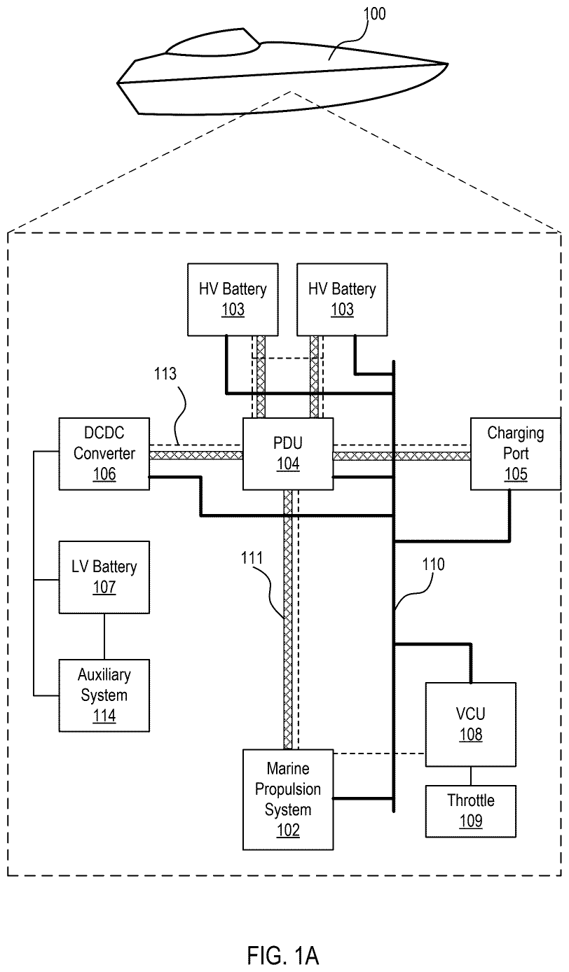

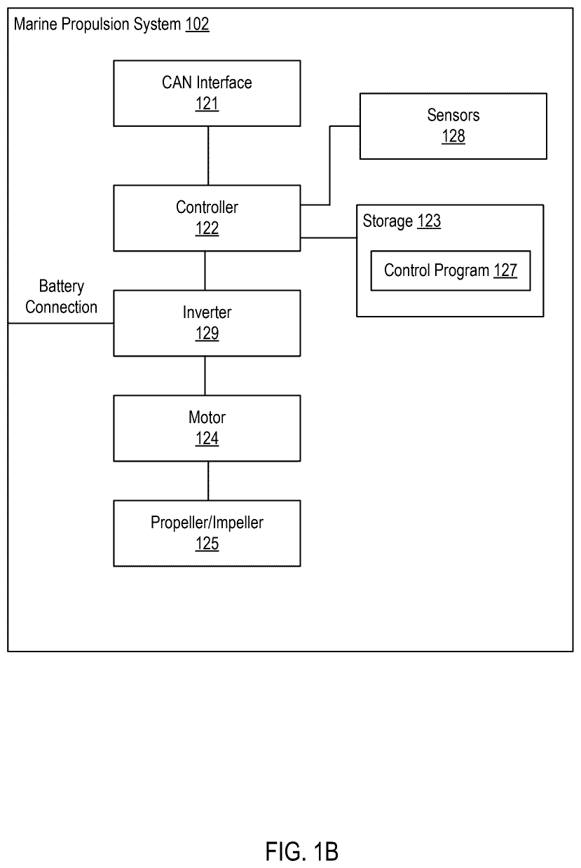

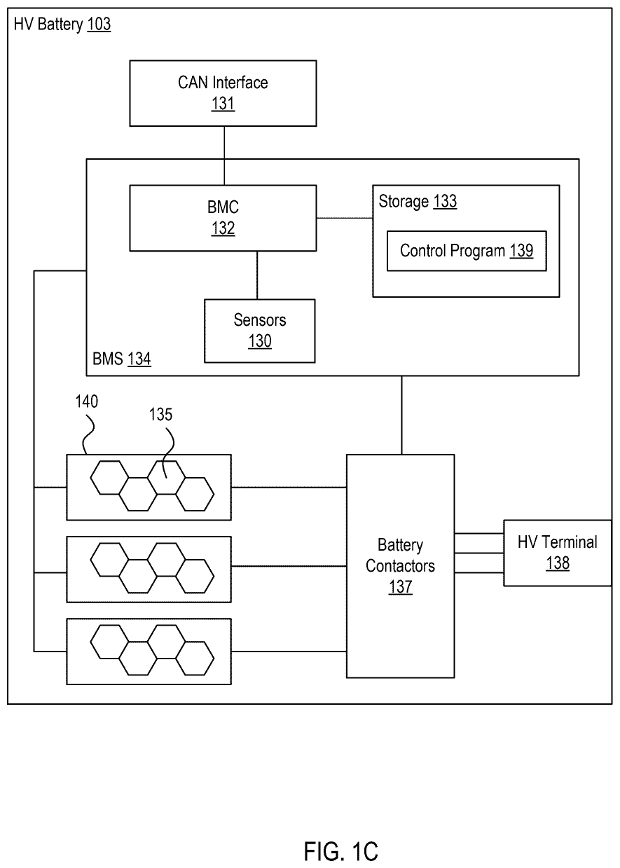

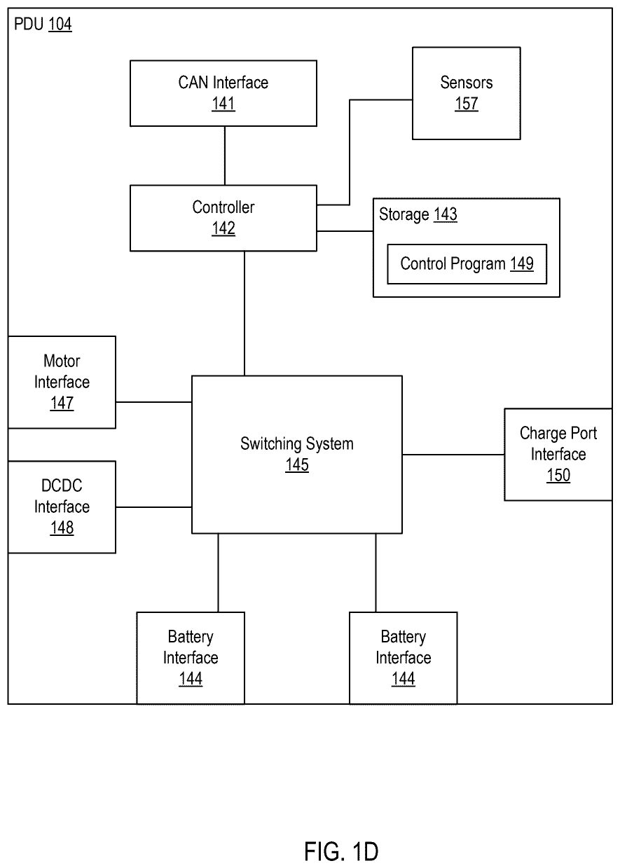

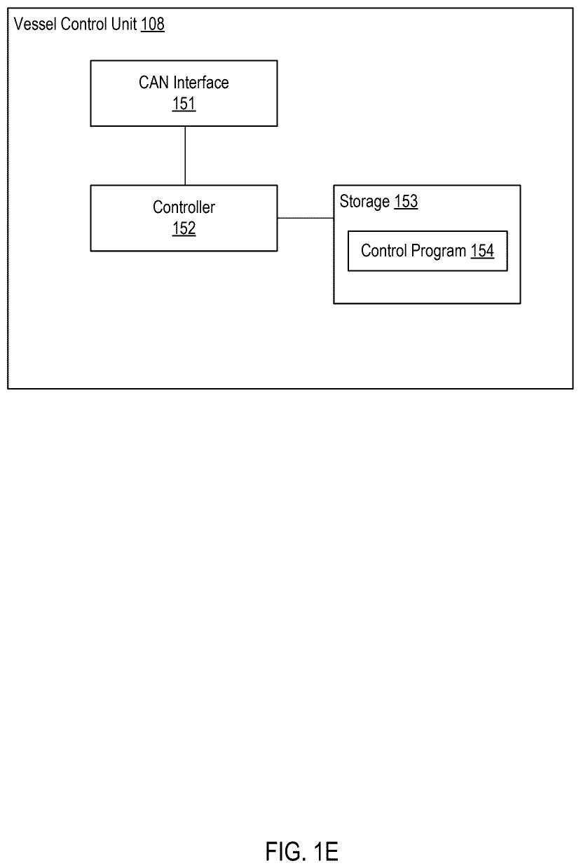

FIG. 1A sets forth an example electric vessel apparatus (hereinafter, “vessel”) 100 for authenticating powertrain components of an electric vessel by a battery management controller in accordance with the present disclosure. FIG. 1A is provided to emphasize the powertrain components of vessel 100. It will be appreciated that vessel 100 may include other components not shown or described herein. Vessel 100 may be any type of watercraft. In a particular example, vessel 100 includes a full-electric powertrain and thus may also referred to as an ‘electric boat.’ To that end, vessel 100 includes a marine propulsion system 102. The marine propulsion system is described in more detail below with reference to FIG. 1B. In a particular example, vessel 102 is a recreational electric boat and marine propulsion system 102 is a full-electric outboard motor powered by high voltage (e.g., 400V or more) batteries.

The marine propulsion system 102 is powered by one or more high voltage batteries 103. In the example, of FIG. 1A, two high voltage batteries 103 are shown; however, it will be appreciated a vessel 100 in accordance with the present disclosure may include fewer or more high voltage batteries. High voltage batteries operate at voltages ranging from a few hundred to over 800 volts, depending on the design and application. Higher voltages allow for more efficient power transmission and reduced current flow, which helps minimize energy losses. Each high voltage battery 103 includes multiple modules, each containing several individual battery cells connected in series and parallel configurations to achieve the desired voltage and capacity. These cells may be arranged in a pack that optimizes space utilization and facilitates thermal management. Each high voltage battery 103 includes or is coupled to a battery management system (BMS). The BMS is responsible for monitoring and controlling various parameters such as voltage, current, temperature, and state of charge (SoC) of individual cells within the pack. The BMS helps optimize battery performance, protect against overcharging or over-discharging, and ensures safety. The BMS communicates with other vessel components about battery state, receives commands to change the battery state, and controls the opening and closing of the main contactors in the battery. The high voltage battery 103 is described in more detail below with reference to FIG. 1C.

The marine propulsion system 102 receives power from the high voltage battery 103 via a power distribution unit (PDU) 104. The PDU 104 receives high-voltage DC power from the high voltage batteries 103 and routes it to different subsystems and components within vessel 100, such as the electric marine propulsion system 102 and other subsystems such as a DCDC converter 106. The PDU 104 also couples the high voltage batteries 103 to a charging port 105 for charging the high voltage batteries 103. The PDU 104, as explained in more detail below with reference to FIG. 1D, includes a set of contactors that are controlled by logic or software in the PDU 104 to ensure safety when switching the flow of power among various vessel components.

The DCDC converter 106 provides voltage conversion capabilities to step down the high-voltage DC power to lower voltages required by an auxiliary system 114, such as the 12-volt electrical system used for lights, accessories, and onboard electronics. The DCDC converter 106 may be used to charge a lower voltage battery such as a 12-volt marine battery 107.

Vessel 100 further includes a vessel control unit (VCU) 108. Vessel control unit 108 serves as the central control unit responsible for managing and coordinating various functions and systems onboard the vessel 100. For example, the vessel control unit 108 can provide propulsion control, including regulating engine speed, torque, and direction to achieve desired propulsion performance and maneuverability in accordance with commands or signals received from the vessel's throttle control 109. The vessel control unit 108 can also manage the vessel's steering system. The vessel control unit 108 can also control startup/shut down routines, control charging/operation mode selection, control the opening and closing of contactors in the PDU 104, monitor the state of onboard systems, perform vessel diagnostics, and interface with an operator dashboard. To that end, the vessel control unit 108 may communicate with the other vessel powertrain components (e.g., the marine propulsion system 102, the high voltage battery 103, the PDU 104, the DCDC converter 106, and so one) via a control area network (CAN), referred to herein as a CAN bus 110. The vessel control unit 108 will be described in more detail below with reference to FIG. 1E.

The CAN bus 110 may be a two-wire serial bus that allows multiple components and devices within a vessel to communicate with each other without a host computer. The CAN bus 110 may use a message-based communication scheme where components and devices send and receive data in the form of messages. Each message includes a CAN identifier (CAN ID), data bytes, and control bits. The CAN bus 110 may employ a multi-master architecture, in that any device on the network can initiate a message transmission. This distributed architecture allows for efficient communication between vessel components without the need for a centralized controller. In a particular example, the CAN bus 110 may implement the NMEA2000 protocol, a standard set forth by the National Marine Electronics Association. NMEA2000 provides optimization and messaging for a marine environment.

Vessel 100 can also include a high voltage interlock loop (HVIL) system, which is a safety feature designed to ensure the safe operation and maintenance of the high-voltage components. HVIL is a dedicated circuit that ensures the high voltage connectors are well inserted in the equipment mating connector to ensure the safety of the high voltage connections. HVIL is used by the high voltage battery BMS and the vessel control unit 108 to confirm the integrity of these connections before applying high voltage energy to each high voltage device in the vessel.

For ease of reference, in FIG. 1A power interconnects 111 supplying high voltage power are shown in hash-filled lines, data interconnects for CAN bus 110 are shown in thick solid black lines, and HVIL interconnects 113 are shown in dashed lines.

For further explanation, FIG. 1B sets forth a block diagram of an example of the electric marine propulsion system 102 in accordance with at least one embodiment of the present disclosure. The example marine propulsion system 102 of FIG. 1B includes a CAN interface 121 for coupling the marine propulsion system 102 to the CAN bus 110. For example, the CAN interface 121 may be a network interface controller configured to send and receive messages in the form of CAN frames over the CAN bus 110.

The example marine propulsion system 102 also includes a controller 122 coupled to the CAN interface 121. The controller 122 may include or implement a processor, a microcontroller, an Application Specific Integrated Circuit (ASIC), a programmable logic array (PLA) such as a field programmable gate array (FPGA), or other data processing unit in accordance with the present disclosure. In some examples, the controller is implemented by a processor or central processing unit configured to execute computer programming instructions, also referred to a computer executable instructions or processor executable instruction. Such instruction can be loaded from and stored in one or more memory devices collectively referred to as storage 123. Storage 123 may include electrically erasable programmable read-only memory (EEPROM) such as Flash memory (e.g., NAND and NOR flash memory or other types of solid-state memory), dynamic random-access memory (DRAM), static RAM (SRAM), magnetic disk storage, and the like. The storage 123 may be integrated with the controller 122 or provided as a separate memory device coupled to the controller 122.

The marine propulsion system 102 also includes an inverter 129 that that is powered by the high voltage batteries 103. The inverter 129 functions to convert the DC current received from the high voltage batteries 103 to alternating current (AC) that can be used by an electric motor. In some examples, the inverter 129 is a high voltage two-phase DC to a high voltage three-phase AC converter. The marine propulsion system also includes an electric motor 124 coupled to a propeller 125. The electric motor 124 is powered by the current received from the inverter 129. The electric motor 124 is an electric traction motor that turns a drive shaft (not shown) that drives the propeller 125. In some examples, the electric motor is a permanent magnet electric motor. The electric motor 124 is designed to withstand exposure to water and corrosive marine environments, featuring waterproof enclosures, sealed bearings, and corrosion-resistant materials to ensure reliable operation in wet conditions. The electric motor 124 operates quietly, producing minimal noise and vibration compared to traditional combustion engines, which contributes to a quieter boating experience as well as reduced noise pollution in aquatic environments. The electric motor 124 offers high efficiency and energy density, allowing electric boats to achieve comparable performance to traditional boats powered by combustion engines while using less energy and producing fewer emissions.

A control program 127 embodied in computer programing instructions is stored within tangible persistent storage of storage 123. When executed by the controller 122, the control program 127 is configured to receive commands from the vessel control unit 108 and control the electric motor 124 in accordance with those commands. For example, the control program 127 may be configured to regulate the distribution of electrical energy from the inverter 129 to the electric motor 124. In this example, the control program 127 may receive a throttle/speed command from the vessel control unit 108 and determine the frequency variation or voltage variation that will enter the electric motor 124 for controlling the vessel's speed. The control program 127 is further configured to receive motor state information from various sensors 128 and supply motor state information and diagnostic information to the vessel control unit 108.

For further explanation, FIG. 1C sets forth a block diagram of an example of the high voltage battery 103 in accordance with at least one embodiment of the present disclosure. The example high voltage battery 103 of FIG. 1C includes a CAN interface 131 for coupling the high voltage battery 103 to the CAN bus 110. For example, the CAN interface 131 may be a network interface controller configured to send and receive messages in the form of CAN frames over the CAN bus 110. The example high voltage battery 103 includes array of battery cells 135 organized into battery modules 140 or battery packs, and a set of battery contactors 137 that selectively couple the battery modules 140 to high voltage terminals 138 of the battery 103.

The example high voltage battery 103 also includes a battery management system (BMS) 134 comprising a battery management controller 132 coupled to the CAN interface 131. Battery management controller 132 may include or implement a processor, a microcontroller, an ASIC, PLA such as an FPGA, or other data processing unit in accordance with the present disclosure. In some examples, battery management controller 132 is implemented by a processor or central processing unit configured to execute computer programming instructions, also referred to a computer executable instructions or processor executable instruction. Such instructions can be loaded from and stored in one or more memory devices collectively referred to as storage 133. Storage 133 may include EEPROM such as Flash memory (e.g., NAND and NOR flash memory or other types of solid-state memory), DRAM, SRAM, magnetic disk storage, and the like. The battery management system 134 further includes a variety of sensors 130 coupled to battery cells and other battery components for collecting battery state information. The storage 133 may be integrated with the battery management controller 132 or provided as a separate memory device coupled to the battery management controller 132.

The BMS 134 includes a control program 139 embodied in computer programing instructions stored in tangible persistent storage of storage 133. In some examples, the control program 139 controls the state of the battery contactors for selectively coupling and decoupling the battery modules 140 to the high voltage terminals 138 of the battery 103. In some examples, the control program 139 also monitors battery state information such as voltage, current, and temperature in battery cells 135 via the above-mentioned sensors. In some examples, the control program 139 also communicates with the vessel control unit 108 to provide battery state information. The control program also controls the charging of the battery cells 135.

For further explanation, FIG. 1D sets forth a block diagram of an example of the PDU 104 in accordance with at least one embodiment of the present disclosure. The example PDU 104 of FIG. 1D includes a CAN interface 141 for coupling the PDU 104 to the CAN bus 110. For example, the CAN interface 141 may be a network interface controller configured to send and receive messages in the form of CAN frames over the CAN bus 110. The PDU 104 also includes a battery interface 144 coupling the high voltage batteries 103 to a switching system 145 of the PDU 104, a charge port interface 150 coupling the charging port 105 to the switching system 145, a motor interface 147 coupling the marine propulsion system 102 to the switching system 145, and a DCDC interface 148 coupling the DCDC converter 106 to the switching system 145. The switching system 145 includes a set of contactors (not shown for simplicity) by which the PDU 104 supplies power from the high voltage batteries 103 to the marine propulsion system 102 and to the DCDC converter 106, or supplies power from the charging port 105 to the high voltage batteries 103.

The example PDU 104 also includes a controller 142 that may include or implement a processor, a microcontroller, an ASIC, PLA such as an FPGA, or other data processing unit in accordance with the present disclosure. In some examples, the controller 142 is implemented by a processor or central processing unit configured to execute computer programming instructions, also referred to a computer executable instructions or processor executable instruction. Such instructions can be loaded from and stored in one or more memory devices collectively referred to as storage 143. Storage 143 may include EEPROM such as Flash memory (e.g., NAND and NOR flash memory or other types of solid-state memory), DRAM, SRAM, magnetic disk storage, and the like. The storage 143 may be integrated with the controller 142 or provided as a separate memory device coupled to the controller 122.

The PDU 104 also includes a control program 149 embodied in computer programing instructions stored in tangible persistent storage of storage 143. When executed by the controller 142, the control program 149 is configured to receive commands from the vessel control unit 108 and control the switching system 145 to connect and disconnect power supplied to vessel components. The control program 149 is also configured to provide state information to vessel control unit 108. State information can be collected using one or more sensors 157.

For further explanation, FIG. 1E sets forth a block diagram of an example of vessel control unit 108 in accordance with at least one embodiment of the present disclosure. The example vessel control unit 108 of FIG. 1E includes a CAN interface 151 for coupling the vessel control unit 108 to the CAN bus 110. For example, the CAN interface 151 may be a network interface controller configured to send and receive messages in the form of CAN frames over the CAN bus 110.

The example vessel control unit 108 also includes a controller 152 that may include or implement a processor, a microcontroller, an ASIC, PLA such as an FPGA, or other data processing unit in accordance with the present disclosure. In some examples, controller 152 is implemented by a processor or central processing unit configured to execute computer programming instructions, also referred to a computer executable instructions or processor executable instruction. Such instructions can be loaded from and stored in one or more memory devices collectively referred to as storage 153. Storage 153 may include EEPROM such as Flash memory (e.g., NAND and NOR flash memory or other types of solid-state memory), DRAM, SRAM, magnetic disk storage, and the like. The storage 153 may be integrated with the controller 152 or provided as a separate memory device coupled to the controller 152.

The vessel control unit 108 also includes a control program 154 embodied in computer programing instructions stored in tangible persistent storage of storage 153. When executed by controller 152, the control program 154 is configured to send commands to other vessel components and receive state information and diagnostic data from vessel components as discussed above.

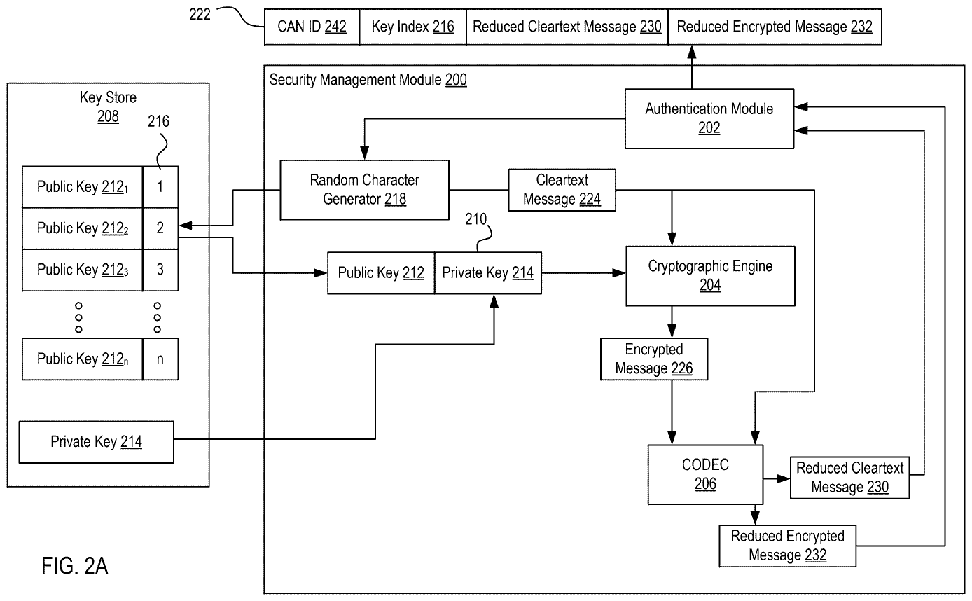

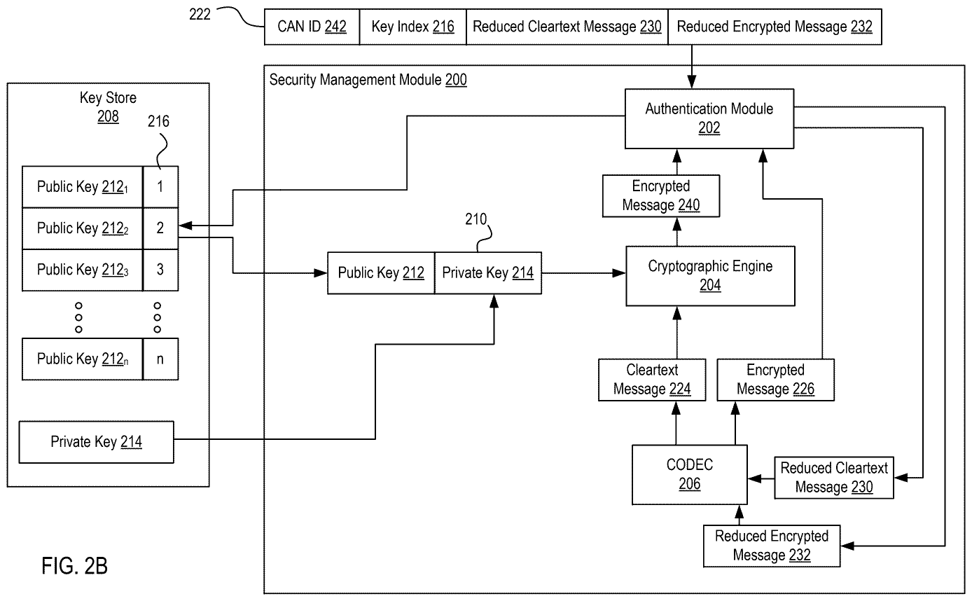

FIG. 2A sets forth an example security management module 200 for authenticating powertrain components of an electric vessel by a battery management controller in accordance with at least one embodiment of the present disclosure. In some examples, the security management module 200 is embodied in a set of computer programing instructions that are stored in a memory (e.g., the storage of FIGS. 1B-1E) that, when executed by a processor, cause the processor to implement the operations described below. In other examples, the security management module 200 may be implemented in digital logic, such as an application specific integrated circuit or programmable logic device.

The security management module 200 of a particular vessel component expects to receive an authentication message from one or more other vessel components. If an expected authentication message is not received, the security management module 200 signals a security error. For example, the list of vessel components for which the authentication message is expected may be stored in a memory device. The list may be a list of CAN identifiers corresponding to the vessel components for which the authentication message is expected. The security management module expects the authentication message at startup or system initialization. Thereafter, the security management module 200 may expect the authentication message based on an authentication schedule, which may be based on a timer. For example, if the security management module 200 does not receive the authentication message by the end of a timeout period since the last authentication message, the security management module 200 may signal a security error. The security management module 200 also authenticates each vessel component for which an authentication message is expected. The authentication of a vessel component is described in more detail below. If authentication of a vessel component fails, the security management module 200 may signal a security error. In response to detecting the security error, the vessel may be disabled. The mechanism for disabling the vessel may depend upon the vessel component that detects the security error, as described below.

In the example of FIG. 2A, the security management module 200 includes a cryptographic engine 204 configured to encrypt and decrypt data. For example, the cryptographic engine 204 can implement the AES128 encryption algorithm to encrypt and decrypt data. It will be appreciated by those of skill in the art that AES128 is discussed as an illustrative example and that a cryptographic engine 204 in accordance with the present disclosure can be implemented using other encryption algorithms and key lengths. For encryption and decryption, the cryptographic engine 204 uses an encryption key 210 stored in a key store 208. The key store 208 is replicated on each genuine component of the vessel. In some examples, an encryption key 210 is produced by concatenating a public key 212 and a private key 214. For example, the public key 212 and the private key 214 are each 64-bit keys. In some implementations, the key store 208 includes multiple public keys 212₁₋ₙ that are each associated with a key index 216. To produce an encryption key 210, the cryptographic engine 204 selects one of the public keys 212₁₋ₙ based on the key index 216 (e.g., generated at random or provided in an authentication message, as discussed below), and concatenates the selected public key with the private key to produce a 128-bit encryption key. In some examples, the key store 208 is implemented by a data structure stored a memory device, such as any of the memory devices previously discussed. In some implementations, the private key 214 is stored separately in a secure storage device (not shown). In some examples, the private key 214 is encoded in all genuine components that are produced for the vessel. Thus, the private key 214 is pre-shared among the vessel components. The cryptographic engine 204 encrypts and decrypts messages using the encryption key 210. For example, a 128-bit encryption key is used to encrypt or decrypt a 128-bit message; however, these key lengths and message lengths are provided for illustrative purposes only. It will be appreciated that other key lengths, message lengths, and encryption algorithms may be employed. Additional explanations regarding encryption keys for encryption and decryption by the cryptographic engine 204 is provided below.

In the example of FIG. 2A, the security management module 200 also includes an encoder/decoder (‘codec’) 206 configured to encode and decode data in accordance with a particular scrambling protocol. For example, to scramble message data, codec 206 selects a subset of bytes of the message, where the byte positions in the data are preconfigured. In one example where 16 bytes of message data are input to the codec 206, the codec 206 selects byte 0, byte 7, byte 8, and byte 15 of the data to reduce the 16-byte message to a 4-byte message. To descramble data, codec 206 receives a subset of bytes of a message and reconstructs the message data from the subset of bytes using a descrambling mechanism. For example, knowing a priori the byte positions of the subset of bytes within the message to be decoded, the descrambling mechanism applies a particular order of XOR, SUM, and SHIFT operations to generate the missing bytes and reconstruct the original message data. In one example, codec 206 receives 4 bytes of message data. Knowing that the 4 bytes correspond to byte 0, byte 7, byte 8, and byte 15 and of the original message data, codec 206 applies the XOR, SUM, and SHIFT operations of the descrambling mechanism to generate the missing bytes of the 16-byte message data.

In the example of FIG. 2A, the security management module 200 also includes a random character generator 218. In some examples, the random character generator 218 generates a random number, or random text that is hashed to create a random number, which can be used as a key index 216 to select a public key 212. In some examples, the random character generator 218 can be used to generate cleartext for an authentication message, which is described in more detail below.

In the example of FIG. 2A, the security management module 200 also includes an authentication module 202 configured to generate authentication messages and authenticate vessel components based on received authentication messages. The operation of the security management module 200 to generate an authentication message 222 is now described. In response to a particular trigger (e.g., a timer or the receipt of an authentication message from another vessel component), the authentication module 202 initiates the generation of the authentication message 222 by requesting a random number from the random character generator 218. The authentication module 202 uses the random number as the key index 216 (e.g., ‘2’) to select a public key 212 (e.g., public key 212₂) from the key store 208. However, in alternative examples, a timer synchronized to the reception of the last CAN frame can be used to generate a random number. The public key 212 is concatenated with the private key 214 to produce the encryption key 210, which is supplied to the cryptographic engine 204.

The authentication module 202 also requests randomly generated text for a cleartext message 224 (e.g., 16 bytes of cleartext) from the random character generator 218. The cleartext message 224 is supplied to the cryptographic engine 204 and to codec 206. The cryptographic engine 204 encrypts the cleartext message 224 using the encryption key 210 to generate an encrypted message 226 (e.g., 16 bytes), which is provided to codec 206. Codec 206 encodes the cleartext message 224 and the encrypted message 226 by reducing the message based on selected byte positions, as discussed above. For example, codec 206 selects byte 0, byte 7, byte 8, and byte 15 of the cleartext message 224 to generate a reduced cleartext message 230 (4 bytes) and selects byte 0, byte 7, byte 8, and byte 15 of the encrypted message 226 to generate a reduced encrypted text message 232 (4 bytes). It will be appreciated that the number of bytes and byte positions used to reduce a message are provided for illustrative purposes only.

The authentication module 202 generates the authentication message 222 by constructing a CAN frame that includes the key index 216, the reduced cleartext message 230, and the reduced encrypted message 232. The authentication message 222 is then transmitted over the CAN bus. In some examples, the authentication message 222 also includes an identifier, such as a CAN identifier, of the vessel component transmitting the authentication message 222.

For further explanation, FIG. 2B illustrates the operation of the security management module 200 to authenticate another vessel component based on an authentication message 222 received from that vessel component. In some examples, the authentication message includes the CAN identifier 242 of the vessel component, a key index 216, the reduced cleartext message 230, and the reduced encrypted message 232. The reduced cleartext message 230 is provided to the codec 206, which reconstructs the cleartext message 224 from the reduced cleartext message 230 based on the known mapping between the bytes of the reduced cleartext message 230 and their byte positions within the cleartext message 224, and further by application of the descrambling mechanism to supply the missing bytes. Likewise, the reduced encrypted message 232 is provided to the codec 206, which reconstructs the encrypted message 226 from the reduced encrypted message 232 based on the known mapping between the bytes of the reduced encrypted message 232 and their byte positions within the encrypted message 226, and further by application of the descrambling mechanism to supply the missing bytes.

The key index 216 provided in the authentication message 222 is used to identify a public key 212 from the key store 208. The authentication module 202 concatenates the corresponding public key 212 with the private key 214 to produce the encryption key 210, which is supplied to the cryptographic engine 204. The cleartext message 224 is also supplied to the cryptographic engine 204, which encrypts the cleartext message 224 to generate another encrypted message 240. The authentication module 202 then compares the received encrypted message 226 to the generated encrypted message 240 to determine whether they are identical. If the encrypted message 226 and the encrypted message 240 are identical, the vessel component associated with the CAN identifier 242 in the authentication message 222 is authenticated, in that the security management module 200 determines that the vessel component is a genuine component. If the encrypted message 226 and the encrypted message 240 are not identical, the security management module 200 may signal to a vessel component controller that one or more vessel components have failed authentication, which allows the vessel component controller to perform an error handling action.

Although the authentication protocol described above includes comparing the received encrypted message 226 to the encrypted message 240 generated by encrypting the cleartext message 224, in alternative implementations the authentication module 202 can decrypt the encrypted message 226 to generate cleartext, and compare that cleartext to the cleartext message 224.

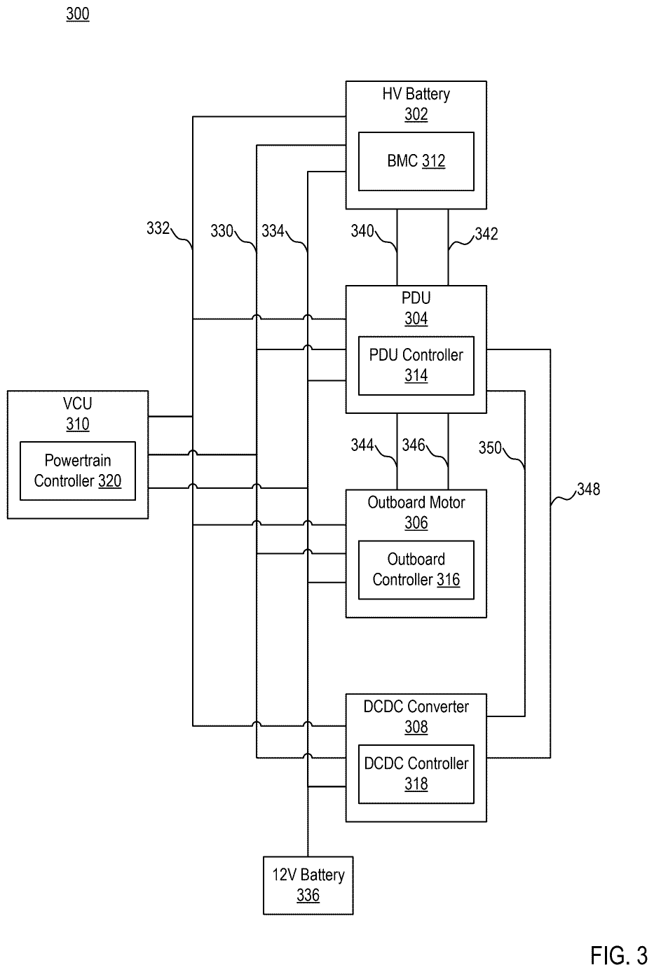

For further explanation, FIG. 3 sets forth an example connection architecture 300 for an example of a distributed control system in an electric vessel. The example architecture 300 includes one or more HV batteries 302 having a BMC 312. Only one HV battery 302 is shown in FIG. 3 for simplicity, although it will be appreciated that architecture 300 may include more than one battery that is connected to system components in the manner that HV battery 302 is connected. In some examples, the HV battery 302 and BMC 312 implement the battery 103 and BMC 132 shown in FIGS. 1A and 1C. In various examples, BMC 312 is implemented by a microcontroller, a processor coupled to a memory, or other digital logic device that will be appreciated by those of skill in the art. As will be discussed in further detail below, BMC 312 implements battery control operations such as opening and closing power contactors, battery state monitoring, and so on.

Architecture 300 also includes a PDU 304 having a PDU controller 314. In some examples, the PDU 304 and PDU controller 314 implement the PDU 104 and PDU controller 142 shown in FIGS. 1A and 1D. In various examples, PDU controller 314 is implemented by a microcontroller, a processor coupled to a memory, or other digital logic device that will be appreciated by those of skill in the art. As will be discussed in further detail below, PDU controller 314 implements PDU control operations such as selectively opening and closing power contactors coupled to the HV battery 302 and motor in accordance with VCU commands and detected faults. PDU 304 is coupled directly to HV battery 302 by high voltage cables 340, which may include, for example, an HV+ cable and an HV− cable. PDU 304 is also coupled directly to HV battery 302 by HVIL wiring 342, which may include two HVIL wires that are part of an HVIL fault detection loop between HV battery 302 and PDU 304.

Architecture 300 also includes electric outboard motor 306 having an outboard controller 316. In some examples, outboard motor 306 and outboard controller 316 implement marine propulsion system 102 and controller 122 of FIGS. 1A and 1B. In various examples, outboard controller 316 is implemented by a microcontroller, a processor coupled to a memory, or other digital logic device that will be appreciated by those of skill in the art. As will be discussed in further detail below, outboard controller 316 implements outboard control operations such as opening and closing power contactors, motor state monitoring, motor speed, propeller direction, and so on. Outboard motor 306 is coupled directly to PDU 304 by high voltage cables 344, which may include, for example, an HV+ cable and an HV− cable. Outboard motor 306 is coupled directly to PDU 304 by HVIL wiring 346, which may include two HVIL wires that are part of an HVIL fault detection loop between outboard motor 306 and PDU 304.

Architecture 300 also includes a DCDC converter 308 having a DCDC controller 318. In some examples, DCDC converter 308 implements DCDC converter 106 in FIG. 1A. In various examples, DCDC controller 318 is implemented by a microcontroller, a processor coupled to a memory, or other digital logic device that will be appreciated by those of skill in the art. As will be discussed in further detail below, DCDC controller 318 implements DCDC converter operations such as charge cycling of a low voltage battery, such as 12V battery 336, as well as supplying power to auxiliary systems. DCDC converter 308 is coupled directly to PDU 304 by high voltage cables 348, which may include, for example, an HV+ cable and an HV− cable. DCDC converter 308 is coupled directly to PDU 304 by HVIL wiring 350, which may include two HVIL wires that are part of an HVIL fault detection loop between DCDC converter 308 and PDU 304.

Architecture 300 also includes a VCU 310 having a powertrain controller 320. In some examples, VCU 310 and powertrain controller 320 implement VCU 108 and controller 152 in FIGS. 1A and 1E. In various examples, powertrain controller 320 is implemented by a microcontroller, a processor coupled to a memory, or other digital logic device that will be appreciated by those of skill in the art. As will be discussed in further detail below, powertrain controller 320 implements powertrain control commands and state monitoring of powertrain components such as HV battery 302, PDU 304, outboard motor 306, and DCDC converter 308. VCU 310 is coupled to HV battery 302, PDU 304, outboard motor 306, and DCDC converter 308 via ignition wire 332. VCU 310 provides an ignition signal using ignition wire 332 by, for example, asserting a voltage on ignition wire 332 that is above a threshold voltage for detection of an ignition signal by a powertrain component. The ignition signal is used to wake up the controllers of the powertrain components, namely, BMC 312, PDU controller 314, outboard controller 316, and DCDC controller 318.

In architecture 300, VCU 310, HV battery 302, PDU 304, and outboard motor 306 are coupled to low voltage power bus 334. As used herein, ‘low voltage’ is contrasted with high voltage supplies of the high voltage batteries, and may refer to a voltage supply of 24V or less. The low voltage power bus 334 can include, for example, a 12V supply wire and a ground wire for reference potential. The 12V supply may be provided by DCDC converter 308, which steps down the high voltage supply from HV battery 302 to a 12V (or other low voltage level) that is usable by vessel electronics and auxiliary systems. Alternatively, the 12V supply can be provided by a 12V battery 336 that is charged by the DCDC converter 308. In various examples, the low voltage power bus 334 provides power to BMC 312, PDU controller 314, outboard controller 316, and VCU powertrain controller 320, as well as power to relays, power contactors, sensors, and other electronic and electromechanical components of the HV battery 302, PDU 304, outboard motor 306, and VCU 310.

VCU 310 is coupled to HV battery 302, PDU 304, outboard motor 306, and DCDC converter 308 via a CAN bus 330. In some examples, CAN bus 330 implements CAN bus 110 of FIG. 1A. All commands and data communication between powertrain components are sent over CAN bus 330 and are implemented through CAN frames, eliminating traditional control wiring. The CAN bus can be implemented using industry-standard protocols such as CAN 2.0 or CAN FD (Flexible Data-rate). In some examples, the bus wiring includes a twisted pair to ensure signal integrity and minimize electromagnetic interference. In some examples, the physical layer can conform to ISO 11898-2 or ISO 11898-3 standards for high-speed or fault-tolerant operation, respectively. Each component on the CAN bus has a unique identifier, allowing precise addressing and prioritization of messages.

In the CAN bus system of FIG. 3, each component is assigned a unique identifier (ID). This identifier is included in the frame header of every message sent over the bus. The identifier can serve two purposes: addressing and prioritization. In a particular embodiment, higher priority messages can be assigned lower numerical IDs and gain access to the bus in case of arbitration conflicts. This ensures time-critical commands, such as motor speed adjustments, are executed without delay.

In some examples, each CAN frame is composed of a header and a data payload. In some examples, the header that includes the identifier, control bits, and data length information. The header ensures that messages are delivered to the intended component while enabling efficient arbitration. The identifier also allows for message filtering, where each device processes only the messages relevant to its operation, ignoring others to reduce processing overhead.

The CAN bus 330 is composed of multiple signal wires, which can include a CAN-high wire that carries the positive differential signal and a CAN-low wire that carries a negative differential signal, which forms a differential pair that minimizes noise. In some examples, the CAN bus signal wires include power supply wire to provide low-voltage power (VCC) to devices on the CAN bus 330 that lack a power supply or where the power supply is disconnected. In these examples, the CAN bus signal wires include a ground wire to provide a reference voltage and ensure signal integrity by reducing electromagnetic interference. Further, the CAN wiring may be sheathed in shielding to protect the signal wiring from interference, and which may be connected to ground.

In some examples, VCU 310 sends commands to HV battery 302 over CAN bus 330 to open or close contactors in the PDU to manage the connection between the batteries and the outboard motor, adjust the speed of the outboard motor by sending appropriate control signals, open or close contactors in the batteries to control power availability, and so on. Types of commands to HV battery 302 can include commands to open or close the main contactor, enable or disable battery output, request state of charge (SoC) or state of health (SoH) data, perform a diagnostic self-test, and/or enter or exit a low-power or storage mode, and so on. Other types of commands could include commands to adjust a charging rate or mode (e.g., fast charge, trickle charge), activate or deactivate thermal management systems, and/or perform a firmware update or controller reset. BMC 312 independently manages and controls the opening of closing of contactors in response to commands as well as automatic opening of specific contactors in response to detecting HVIL faults. In some examples, no other control signals are provided from VCU 310 to HV battery 302 other than the ignition signal over ignition wire 332 and control commands over CAN bus 330. In other words, neither VCU 310 nor any other device exerts direct control over the contactor states of the HV battery contactors, as full control of battery is vested in BMC 312. Further, BMC 312 independently manages the cooling and charge states of battery cells in HV battery 302.

HV battery 302 also reports state information to VCU 310 over CAN bus 330. For example, such state information can include an SoC indicating current charge level, typically expressed as a percentage, and overall condition of the battery, indicating its capacity relative to its original capacity, the current voltage of the battery pack or individual cells, current being supplied or drawn by the battery, and temperature readings within the battery pack and individual cells to prevent overheating. The state information reported can also include information such as the power output being delivered by the battery in watts or kilowatts, connection status indicating whether the battery is connected or disconnected via its contactors, and/or internal resistance within the battery, which can indicate degradation over time. The state information reported can also include information such as fault or error codes including diagnostic information indicating issues such as overvoltage, undervoltage, and/or short circuits, as well as safety alarms for critical conditions like thermal runaway, overcurrent, and/or voltage imbalances. The state information reported can also include information such as the number of charge-discharge cycles the battery has undergone and whether the battery is charging, discharging, or idle.

In some examples, VCU 310 sends commands over to PDU 304 over command bus 330 to open or close specific power contactors, enable or disable power distribution to the outboard motor 306, execute a safety shutdown in response to faults reported by other components, report diagnostic information, and/or perform a firmware update or controller reset, and so on. PDU controller 314 independently manages and controls the opening of closing of contactors in response to commands as well as automatic opening of specific contactors in response to detecting HVIL faults. In some examples, no other control signals are provided from VCU 310 to PDU 304 other than the ignition signal over ignition wire 332 and control commands over CAN bus 330. In other words, neither VCU 310 nor any other device exerts direct control over the contactor states of the PDU contactors, as full control of the PDU is vested in the PDU controller 314.

PDU 304 also reports state information to VCU 310 over CAN bus 330. For example, such state information can include operational status such as active, idle, or fault. The state information reported can include contactor statuses, including the open/closed state of each contactor and faults or malfunctions in contactor operation, as well as connection status such as which HV batteries are currently connected or disconnection and the connection status to outboard motor 306. In some examples, such state information reported can include power flow metrics such as real-time power being distributed, voltage and current being supplied to outboard motor 306, and voltage and current being received from each HV battery. In some examples, state information reported can include temperature readings to monitor temperature within the PDU for overheating or temperatures of individual components such as contactors and relays. In some examples, the state information reported can include fault or error conditions such as overcurrent condition, overvoltage or undervoltage conditions, and short circuit detection. In some examples, the state information reported can include the state of the HVIL and faults or interruptions of the HVIL circuit as well as other alerts for conditions requiring immediate attention (e.g., thermal issues, electrical faults, etc.).

In some examples, VCU 310 sends commands to outboard motor 306 over CAN bus 330 to increase or decrease motor speed (RPM), increase or decrease torque, reverse or forward propeller rotation, report real-time diagnostics or error codes, execute predefined performance modes (e.g., economy, sport), and/or perform a firmware update or controller reset, and so on. Outboard motor 306 independently manages and controls the opening of closing of contactors in response to commands as well as automatic opening of specific contactors in response to detecting HVIL faults. In some examples, no other control signals are provided from VCU 310 to outboard motor 306 other than the ignition signal over ignition wire 332 and control commands over CAN bus 330. In other words, neither VCU 310 nor any other device exerts direct control over the contactor states of the motor contactors and speed/torque of the propeller. Outboard controller 316 independently manages and controls the propeller speed, torque, and direction, as well as the cooling of propulsion system components.

Outboard motor 306 also reports state information to VCU 310 over CAN bus 330. In some examples, the state information reported can include an operational status (e.g., active, idle, or fault mode) of the outboard motor 306, motor speed and RPM, instantaneous torque output, and/or direction of rotation (e.g., forward or reverse). In some examples, the state information reported can also include real-time power consumption in watts or kilowatts, real-time voltage and current draw, internal motor temperature to prevent overheating, error codes and diagnostics to indicate operational issues, and/or efficiency metrics (e.g., percentage efficiency or power losses). In some examples, the state information reported can include the state of the HVIL and faults or interruptions of the HVIL circuit as well as other alerts for conditions requiring immediate attention (e.g., thermal issues, electrical faults, etc.).

In some examples, VCU 310 sends commands to DCDC converter 308 to report diagnostic information, enable or disable power to auxiliary systems, open or close contactors, and so on. DCDC converter 308 also reports state information to VCU 310 over CAN bus 330. In some examples the state information for the DCDC converter 308 includes real-time output voltage and current, input voltage, and power metrics such as input power, output power, and conversion efficiency. In some examples, the state information reported includes temperature readings for thermal management, operational status (e.g., active, idle, fault), and safety alarms for conditions like overvoltage, undervoltage, overcurrent, or thermal shutdown. In some examples, the state information reported includes diagnostic fault codes, and connection statuses to the low voltage battery and auxiliary systems. In some examples, the state information reported can include the state of the HVIL and faults or interruptions of the HVIL circuit as well as other alerts for conditions requiring immediate attention (e.g., thermal issues, electrical faults, etc.).

Each powertrain component's controller processes the received CAN commands and independently executes the required action without further control by VCU 310 or any other device. For example, the motor controller adjusts speed based on the VCU's commands, while the PDU controller controls contactor opening and closing to enable safe operation. VCU 310 has no direct controller DCDC contactor opening/closing, as full control of the DCDC converter is vested in DCDC controller 318.

In this way, the distributed control architecture in accordance with the present disclosure reduces complexity by utilizing a CAN bus for control, and the invention eliminates the need for traditional wiring, reducing system complexity and weight. The distributed control architecture in accordance with the present disclosure enhances reliability by ensuring that each component operates independently while being coordinated by the VCU. The distributed control architecture in accordance with the present disclosure improves safety with HVIL connections that provide a robust safety mechanism, preventing accidental operation and ensuring proper system integration. The distributed control architecture in accordance with the present disclosure improves scalability in that the modular design allows easy integration of additional components or functionalities without significant redesign.

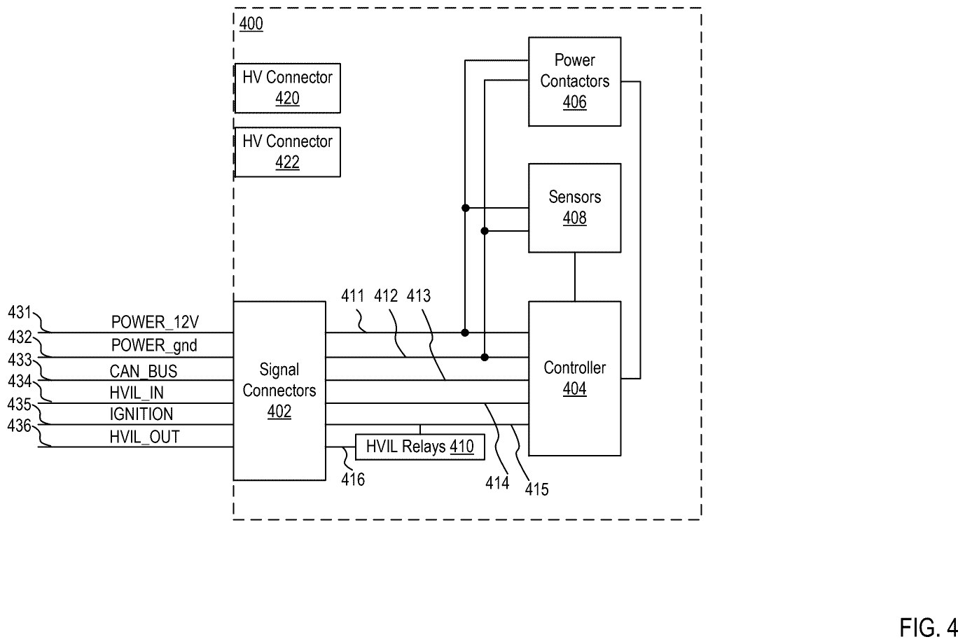

For further explanation, FIG. 4 sets forth a signal diagram of an example powertrain component 400 component for a distributed control system architecture for an electric marine vessel in accordance with at least one embodiment of the present disclosure. The example powertrain component can be, for example, HV battery 302, PDU 304, outboard motor 306, or DCDC converter 308 of FIG. 3. The powertrain component 400 includes a controller 404 (e.g., BMC 312, PDU controller 314, outboard controller 316, DCDC controller 318) that independent manages the operation of the powertrain component in response to commands transmitted over the CAN bus and faults detected via the HVIL circuit, as discussed above. Powertrain component 400 also includes one or more power contactors 406 that are coupled to HV power cables via HV connectors 420, 422. Although not shown in FIG. 4, in the case that powertrain component 400 is an HV battery, power contactors 406 would be coupled to battery cells; similarly, in the case that powertrain component 400 is an outboard motor, power contactors 406 would be coupled to an inverter drives a motor. Powertrain component 400 also includes one or more sensors 408 for collecting information related to the state of the powertrain component. For example, sensors 408 can collect information about the states of various contactors, temperature states, battery cell states, connection states, motor states, propeller states, etc. This information can be used by controller 404 to send state information to a VCU.

In some examples, in addition to power cables coupled to HV connectors 420, 422, a wire harness coupled to one or more connectors 402 of the powertrain component 400 includes power wire 431 (POWER_12V) and ground wiring 432 (POWER_gnd) coupled to connectors 402, which provide a power signal 411 and ground reference 412 to controller 404, contactors 406, sensors 408, and other electronic components of powertrain component 400. The wire harness coupled to one or more connectors 402 of the powertrain component 400 includes CAN bus wiring 433 (CAN_BUS) that provides CAN bus signals 413 to controller 404. The CAN bus wiring includes a plurality of wires that can include wiring for a variety of CAN signals including, for example, CAN bus high signals, CAN bus low signals, diagnostic CAN bus signals, power, and ground. The wire harness coupled to one or more connectors 402 of the powertrain component 400 also includes an HVIL input wire 434 (HVIL_IN) and HVIL output wire 436 (HVIL_OUT) for fault detection by the controller 404. The HVIL input signal 414 received via the HVIL input wire 434 is used by the controller 404 to detect HVIL status, for example, by detecting an interrupt in the HVIL circuit formed with another powertrain component. An HVIL output signal is generated using a 12V power signal, such as the ignition signal, and output over the HVIL output wire 436 to the other powertrain components. The wire harness coupled to one or more connectors 402 of the powertrain component 400 also includes an ignition wire 435 that provides an ignition signal 415 to controller 404. The ignition signal 415 is utilized as a wake-up signal to bring controller 404 out of an inactive or sleep state.

In some examples, in response to ignition signal 415 going high, controller 404 will wake up and place the powertrain component in an active state, execute any initialization procedures, and then close power contactors 406 to supply or receive HV power. In response to the ignition signal 415 going low, controller 404 will open contactors 406 and place powertrain component in an idle state. In a failure state, from detecting an HVIL interrupt, controller 404 opens one or more of contactors 406. In a particular implementation, controller 404 wakes up only when ignition signal 415 is high and power signal 411 is high. In various examples, the HVIL circuit can be powered by the power signal 411 or the ignition signal 415. In some examples, CAN bus communication is only enabled when ignition signal 415 is high.

In a particular implementation as shown in FIG. 4, the ignition signal 415 provides 12V supply for the HVIL and for controller 404 wake-up. The ignition signal 415 is routed through one or more HVIL relays 410 that are configured to open in response to detecting a disconnection of a power cable from HV connectors 420, 422. The ignition signal 415, routed through HVIL relays, is then provided as the HVIL output signal 416 over the HVIL output wire 436 coupled to connectors 402. HVIL_IN input signal 414 is the same signal after being routed to through another power train component and its HVIL relays, and back to powertrain component 400 over HVIL input wire 434. Controller 404 determines the HVIL status by the integrity of the signal received from the HVIL input wire 434. An interrupt in the HVIL circuit between powertrain component 400 and another powertrain component will trigger a failure state by controller 404. It will be appreciated that, while only one pair of HVIL wires are shown for connection to one other powertrain component, some powertrain components may have HV connections to multiple powertrain components, such as a PDU to multiple HV batteries. In those cases, the wire harness for powertrain component 400 may include multiple HVIL input/output pairs.

In some examples, where powertrain component 400 is a VCU, or in other cases where no HV connections are present, the HVIL input and HVIL output may be omitted from the wire harness coupled to connectors 402 of powertrain component 400. In some examples, the wire harness coupled to a powertrain component may include additional data wires, such as data wires to indicate an ID of the powertrain component.

In view of the above, it will be appreciated that, in some implementations, no control wiring is coupled to powertrain component 400 other than ignition wire 435 for providing the wake-up signal to controller 404 and CAN bus wiring 433 for receiving control commands from a VCU and sending state data to the VCU. That is, each powertrain component includes a controller that independently manages the operation of the powertrain component based on commands received from the VCU over the CAN bus. Thus, in some examples, a powertrain component (e.g., HV battery, PDU, outboard motor, DCDC converter) is coupled only to HV cables, HVIL wiring, CAN bus wiring, low volage power and ground wiring, and an ignition wire.

In this way, the wire connections of the powertrain component of FIG. 4, in accordance with the present disclosure, reduces complexity by utilizing a CAN bus for control, and the invention eliminates the need for traditional wiring, reducing system complexity and weight. The distributed control architecture in accordance with the present disclosure enhances reliability by ensuring that each component operates independently while being coordinated by the VCU. The distributed control architecture in accordance with the present disclosure improves safety with HVIL connections that provide a robust safety mechanism, preventing accidental operation and ensuring proper system integration. The distributed control architecture in accordance with the present disclosure improves scalability in that the modular design allows easy integration of additional components or functionalities without significant redesign.

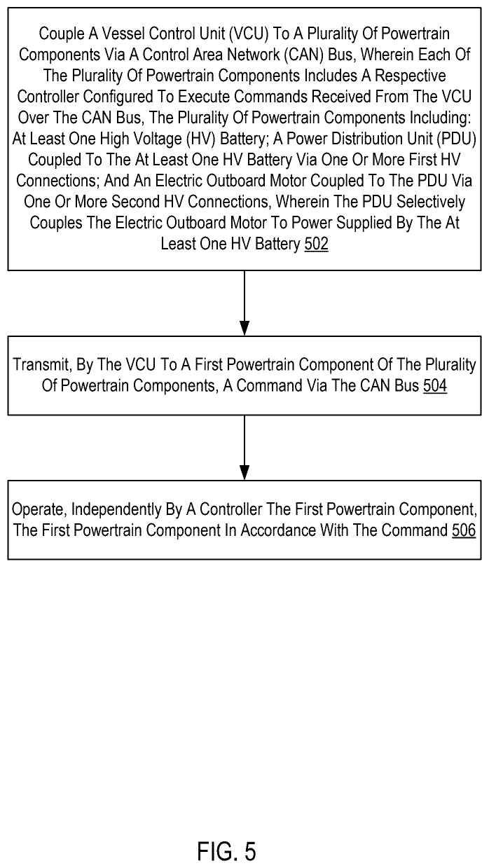

For further explanation, FIG. 5 sets forth a flow chart of an example method of operating a distributed control system architecture for an electric marine vessel in accordance with at least one embodiment of the present disclosure. The method of FIG. 5 includes coupling 502 a vessel control unit (VCU) to a plurality of powertrain components via a control area network (CAN) bus, wherein each of the plurality of powertrain components includes a respective controller configured to execute commands received from the VCU over the CAN bus. The plurality of powertrain components includes at least one high voltage (HV) battery, a power distribution unit (PDU) coupled to the at least one HV battery via one or more first HV connections, and an electric outboard motor coupled to the PDU via one or more second HV connections, wherein the PDU selectively couples the electric outboard motor to power supplied by the at least one HV battery. In some examples, the VCU and powertrain components are coupled as shown and described above with reference to FIGS. 3 and 4. In some implementations, the control wiring between the VCU and the powertrain component consists of an ignition wire and CAN bus wiring, the ignition wire being configured to convey a controller wake-up signal. No other external control signals, other than the ignition signal and CAN bus commands, are received by the powertrain component from the VCU or other vessel components. In some variations, the PDU may also receive an emergency stop signal that is coupled to a physical button accessible to the operator of the vessel.

In some examples, the VCU transmits an authentication message, as discussed above in relation to FIGS. 2A and 2B, to authenticate each powertrain component. In response to receiving a valid authentication reply, the VCU determines each powertrain component is genuine. In response to receiving an invalid authentication reply, the VCU sends one or more commands to one or more powertrain components to open power contactors.

The method of FIG. 5 also includes transmitting 504, by the VCU to a first powertrain component of the plurality of powertrain components, a command via the CAN bus. In some examples, the VCU transmit 504 a command by sending a CAN frame over the CAN bus that includes data for the command. In some examples, the first powertrain component reads the command in response to detecting an identifier of the first powertrain component in the header of the CAN frame. In various examples, the command may be a command to open or close contactors, increase or decrease the speed of the outboard motor, report state information, reverse the direction of the propeller or steer the outboard motor/propeller, and other types of commands discussed above.

The method of FIG. 5 also includes operating 506, independently by a controller, the first powertrain component, the first powertrain component in accordance with the command. In some examples, the controller of the powertrain component operates 506 the powertrain component by controlling various components of the powertrain component to carry out the command. For example, the controller may control contactors to open or close, may control the motor to increase or decrease speed, and so on. In some examples, the first powertrain component receives control signals for the powertrain component exclusively through the first connector and the CAN bus connector. In some examples, the controller is configured to transition the powertrain component to an active state in response to detecting an ignition signal received via the first connector. In some examples, the controller is configured to report state information of the powertrain component via the CAN bus connector. In some implementations, all state information of the powertrain component is reported via the CAN bus connector. In some implementations, a set of all low voltage electrical signals (24V or less) received by the powertrain component includes an ignition signal, one or more CAN bus signals, a low voltage power signal, a ground reference signal, and one or more HVIL signals.

In some examples, the first powertrain component includes an HVIL input connector and an HVIL output connector, the HVIL input connector and HVIL output connector being couplable to another powertrain component, where the ignition signal received via an ignition connector is used to supply an HVIL output signal to the HVIL output connector, and wherein the controller is configured to detect an interruption in an HVIL input signal.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An electric marine vessel apparatus comprising:
a vessel control unit (VCU);
a plurality of powertrain components including:
at least one high voltage (HV) battery;
a power distribution unit (PDU) coupled to the at least one HV battery via one or more first HV connections; and
an electric outboard motor coupled to the PDU via one or more second HV connections, wherein the PDU selectively couples the electric outboard motor to power supplied by the at least one HV battery; and
a control area network (CAN) bus coupling the VCU to the plurality of powertrain components, wherein each of the plurality of powertrain components includes a respective controller configured to execute commands received from the VCU over the CAN bus.

2. The electric marine vessel apparatus of claim 1, wherein the plurality of powertrain components includes a direct current-to-direct current (DCDC) converter.

3. The electric marine vessel apparatus of claim 1, wherein the respective controller of a powertrain component is configured to independently operate the powertrain component based on the commands received from the VCU.

4. The electric marine vessel apparatus of claim 3, wherein, after receiving a controller wake-up signal, all signal communication between the powertrain component and the VCU is exclusively transmitted over the CAN bus.

5. The electric marine vessel apparatus of claim 3, wherein control wiring between the VCU and the powertrain component consists of an ignition wire and CAN bus wiring, the ignition wire being configured to convey a controller wake-up signal.

6. The electric marine vessel apparatus of claim 3, wherein a set of all low voltage electrical signals received by the powertrain component includes an ignition signal, one or more CAN bus signals, a low voltage power signal, a ground reference signal, and one or more High-Voltage Interlock Loop (HVIL) signals.

7. A powertrain component for an electric marine vessel, the powertrain component comprising:
one or more high voltage connectors;
a first connector couplable to an ignition wire;
a control area network (CAN) bus connector couplable to a CAN bus; and
a controller configured to independently operate the powertrain component based on commands received via the CAN bus from a vessel control unit (VCU).

8. The powertrain component of claim 7, wherein control signals for the powertrain component are received exclusively through the first connector and the CAN bus connector.

9. The powertrain component of claim 7, wherein the controller is configured to:
transition the powertrain component to an active state in response to detecting an ignition signal received via the first connector; and
operate the powertrain component based on one or more commands received via the CAN bus connector.

10. The powertrain component of claim 9, wherein the controller is configured to:
report state information of the powertrain component via the CAN bus connector.

11. The powertrain component of claim 10, wherein all state information of the powertrain component is reported via the CAN bus connector.

12. The powertrain component of claim 7, wherein the powertrain component is a high voltage battery.

13. The powertrain component of claim 7, wherein the powertrain component is a power distribution unit.

14. The powertrain component of claim 7, wherein the powertrain component is an electric outboard motor.

15. The powertrain component of claim 7, wherein the powertrain component is a direct current-to-direct current (DCDC) converter.

16. The powertrain component of claim 7, wherein a set of all low voltage electrical signals received by the powertrain component includes an ignition signal, one or more CAN bus signals, a low voltage power signal, a ground reference signal, and one or more High-Voltage Interlock Loop (HVIL) signals.

17. The powertrain component of claim 7 further comprising a High-Voltage Interlock Loop (HVIL) input connector and an HVIL output connector, the HVIL input connector and HVIL output connector being couplable to another powertrain component.

18. The powertrain component of claim 17, wherein an ignition signal received via the first connector is used to supply an HVIL output signal to the HVIL output connector, and wherein the controller is configured to detect an interruption in an HVIL input signal.

19. A method of operating a distributed control system architecture for an electric marine vessel, the method comprising:
coupling a vessel control unit (VCU) to a plurality of powertrain components via a control area network (CAN) bus, wherein each of the plurality of powertrain components includes a respective controller configured to execute commands received from the VCU over the CAN bus, the plurality of powertrain components including:
at least one high voltage (HV) battery;
a power distribution unit (PDU) coupled to the at least one HV battery via one or more first HV connections; and
an electric outboard motor coupled to the PDU via one or more second HV connections, wherein the PDU selectively couples the electric outboard motor to power supplied by the at least one HV battery;
transmitting, by the VCU to a first powertrain component of the plurality of powertrain components, a command via the CAN bus; and
operating, independently by a controller the first powertrain component, the first powertrain component in accordance with the command.

20. The method of claim 19, wherein a set of all low voltage electrical signals received by each powertrain component includes an ignition signal, one or more CAN bus signals, a low voltage power signal, a ground reference signal, and one or more High-Voltage Interlock Loop (HVIL) signals.
